(19) United States
(12) Patent Application Publication
(10) Pub. No.: US 2021/0238911 A1
(43) Pub. Date: Aug. 5, 2021

(54) FLOOD BARRIER WINDOW SYSTEM

(71) Applicant: Fenex, LLC, Juno Beach, FL (US)

(72) Inventor: Stephane Theriault, Boca Raton, FL (US)

(73) Assignee: Fenex, LLC, Juno Beach, FL (US)

(21) Appl. No.: 17/169,149

(22) Filed: Feb. 5, 2021

Related U.S. Application Data
(60) Provisional application No. 62/970,477, filed on Feb. 5, 2020.

(51) Int. Cl. E06B 3/26; E06B 1/36; E06B 1/60; E06B 5/10

(52) U.S. Cl. CPC E06B 3/2605; E06B 1/36; E06B 1/18; E06B 5/10; E06B 1/6015

(57) ABSTRACT

According to one example, a window system includes a window and further includes a frame that can be coupled to an opening in a structure. The frame includes one or more window seats and one or more moveable window stops. The one or more window seats can surround all or a portion of a periphery of the window. The one or more moveable window stops can be moved and coupled to different positions along a depth of the one or more window seats. The window includes a first window portion, a second window portion, and an interlayer positioned in-between the first window portion and the second window portion. The interlayer extends out of the periphery of the window.

### CROSS REFERENCE TO RELATED APPLICATION

This application claims priority to U.S. Provisional Patent Application No. 62/970,477 filed Feb. 5, 2020, the entirety of which is incorporated herein by reference.

### TECHNICAL FIELD

This disclosure relates generally to flood control devices and more particularly to a flood barrier window system.

### BACKGROUND

Traditionally, windows (and even impact windows) are not designed to provide protection against flood events. Furthermore, even when a window can provide some protection against flood events, such traditional windows may be deficient.

### SUMMARY

In one example, a window system includes a window and further includes a frame that can be coupled to an opening in a structure. The frame includes one or more window seats and one or more moveable window stops. The one or more window seats can surround all or a portion of a periphery of the window. The one or more moveable window stops can be moved and coupled to different positions along a depth of the one or more window seats. The window includes a first window portion, a second window portion, and an interlayer positioned in-between the first window portion and the second window portion. The interlayer extends out of the periphery of the window.

In such an example, the interlayer can extend in-between at least a portion of both the one or more window seats and the one or more moveable window stops. In another such example, the interlayer wraps around at least a portion of the periphery of the second window portion, wraps around a side of the second window portion, and extends vertically along a portion of the side of the second window portion.

In a second example, a method includes positioning one or more window seats of a frame along all or a portion of a periphery of a window. The window includes a first window portion, a second window portion, and an interlayer positioned in-between the first window portion and the second window portion, and that extends out of the periphery of the window. The method further includes coupling one or more moveable window stops of the frame to the one or more window seats at a position along a depth of the one or more window seats. This position along the depth is based on a thickness of the window. The method also includes inserting the frame and the window into an opening in a structure, and coupling the frame to the opening in the structure.

In a third example, a window system includes a window and further includes a frame that can be coupled to an opening in a structure. The window includes a first window portion, a second window portion, and an interlayer positioned in-between the first window portion and the second window portion. The interlayer also extends out of the periphery of the window and wraps around at least a portion of the periphery of the second window portion. The frame includes one or more window seats. Also, an exterior-facing surface of each of the one or more window seats can be coupled to an interior-facing surface of the window.

In a fourth example, a method includes inserting one or more window seats of a frame into an opening in a structure, coupling the frame to the opening in the structure, and coupling an interior-facing surface of a window to an exterior-facing surface of each of the one or more window seats. The window includes a first window portion, a second window portion, and an interlayer positioned in-between the first window portion and the second window portion. The interlayer also extends out of the periphery of the window and wraps around at least a portion of the periphery of the second window portion.

Certain examples of the disclosure may provide one or more technical advantages. For example, the flood barrier window system may provide a transparent (or semi-transparent) barrier in the structure, while still providing protection against flood events. In some examples, the flood barrier window system may provide protection against a flood event that has a force of up to a load of 10 feet of water or more (e.g., an impact of 4,000 pounds or more).

Certain examples of the disclosure may include none, some, or all of the above technical advantages. One or more other technical advantages may be readily apparent to one skilled in the art from the figures, descriptions, and claims included herein.

### BRIEF DESCRIPTION OF THE FIGURES

For a more complete understanding of the present disclosure and its features and advantages, reference is now made to the following description, taken in conjunction with the accompanying drawings, in which:

FIG. 1A illustrates a perspective view of an example flood barrier window system.

FIG. 1B illustrates a cross-sectional view at section 1B-1B of the example flood barrier window system of FIG. 1A.

FIG. 1C illustrates an exploded view of the frame of FIG. 1B;

FIGS. 2A-2B illustrate examples of the coupling of two window seats together at a corner of a window of FIG. 1A.

FIG. 3 illustrates an example of an interlayer of FIG. 1B extending out of the periphery of the window and further extending in-between the window stop and the window seat.

FIG. 4 illustrates a cross-sectional view of another example of a flood barrier window system.

FIG. 5 illustrates a cross-sectional view of a further example of a flood barrier window system.

FIG. 6 illustrates a cross-sectional view of another example of a window seat of a flood barrier window system.

FIGS. 7-19 each illustrate a cross-sectional view of a further example of a flood barrier window system.

### DETAILED DESCRIPTION

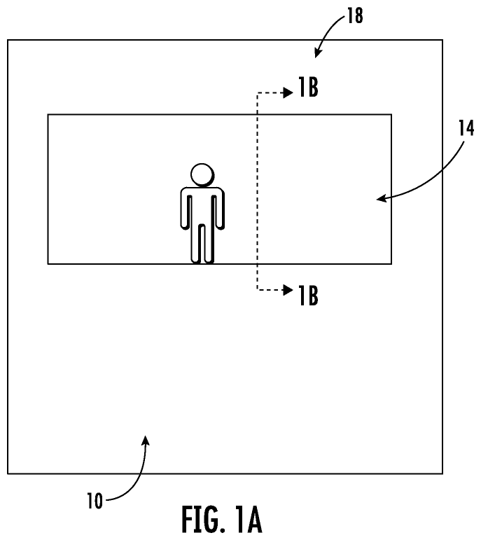

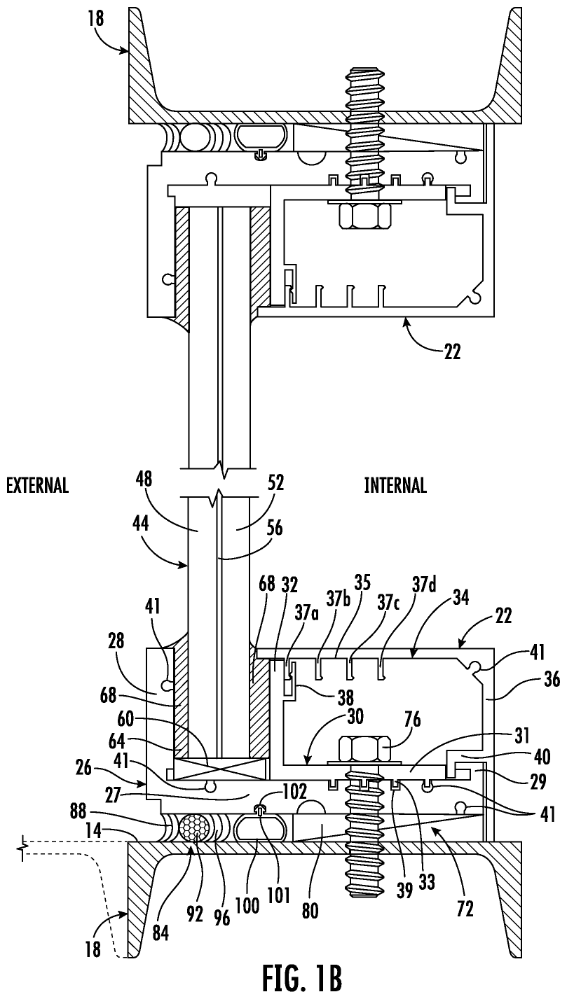

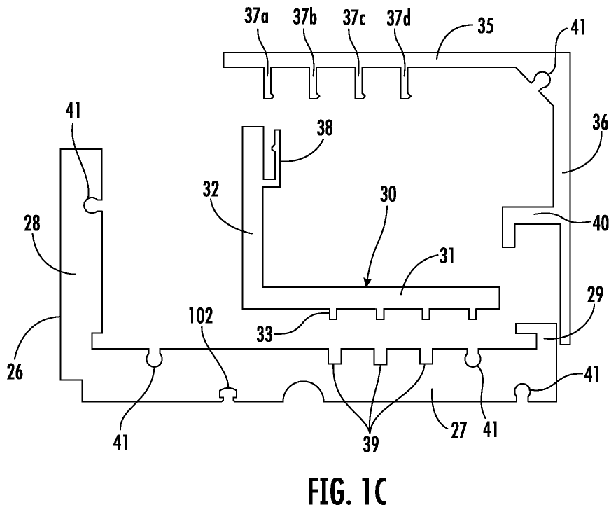

Examples in the present disclosure are best understood by referring to FIGS. 1A-19 of the drawings, like numerals being used for like and corresponding parts of the various drawings.

FIGS. 1A-1C illustrate an example of a flood barrier window system 10. The flood barrier window system 10 may be inserted (or otherwise installed) into an opening 14 in a structure 18, such as an opening in a building, a wall, any other structure, or any combination of the preceding. The flood barrier window system 10 may provide a transparent (or semi-transparent) barrier in the structure 18. This barrier may provide protection from one or more elements (e.g., wind, rain, cold, heat, etc.), but may also allow a user (or a device) to see through the barrier. As such, the flood barrier window system 10 may provide protection to a user (and/or to the structure 18 itself), while still allowing a user to view the environment outside (and/or inside) the structure 18.

In some examples, the flood barrier window system 10 may provide protection against flood events. For example, the flood barrier window system 10 may be able to resist forces caused by flooding fluids (and/or caused by objects, such as debris, included in the flooding fluids). In some examples, the flood barrier window system 10 may provide protection against a flood event that has a force of up to a load of 10 feet of water or more (e.g., an impact of 4,000 pounds or more). This may, in some examples, allow the flood barrier window system 10 to provide protection in areas that are prone to floods (such as in coastal areas and areas below and/or near sea level), while still providing an aesthetically pleasing (and useful) transparent (or semi-transparent) barrier. For example, the flood barrier window system 10 may be used as a sea wall (or as part of a sea wall). As another example, the flood barrier window system 10 may be used in homes and/or offices near the coast, near waterways, or near areas that are prone to floods.

Traditionally, windows (and even impact windows) are not designed to provide protection against flood events. Furthermore, even the windows that can provide protection against flood events are only capable of providing protection against a flood event that has a force of up to 6 feet of water, at the most. As such, flood protection is traditionally provided by non-transparent materials (such as concrete and/or steel). In contrast to this, the flood barrier window system 10 may, in some examples, provide a transparent (or semi-transparent) barrier that may provide protection against a flood event that has a force of up to a load of 10 feet of water or more (e.g., an impact of 4,000 pounds or more).

FIG. 1B illustrates a cross-sectional view at section 1B-1B of the example flood barrier window system 10 of FIG. 1A. As is illustrated, the flood barrier window system 10 may provide a barrier in-between a location external to the flood barrier window system 10 (e.g., where the external location is on the left side of FIG. 1B) and a location internal to the flood barrier window system 10 (e.g., where the internal location is on the right side of FIG. 1B). The internal location may correspond to a location inside of the structure 18, such a location inside of a building. The external location may correspond to a location outside of the structure 18, such as a location outside of the building.

As illustrated in FIG. 1B, the flood barrier window system 10 includes a frame 22, a window 44, and a connection system 72. The frame 22 may hold the window 44 within the opening 14 of the structure 18, and may further provide a barrier against one or more elements along a periphery of the window 44. The window 44 may provide a transparent (or semi-transparent) barrier against one or more elements. The connection system 72 may hold the frame 22 and the window 44 within the opening 14 of the structure 18, and may further provide a barrier against one or more elements along a periphery of the frame 22 (e.g., it may provide a barrier in the gap in-between the frame 22 and the structure 18).

According to the illustrated example, the frame 22 includes a window seat 26, a window stop 30, and a cap 34. The window seat 26 may be a portion of the frame 22 that surrounds all or a portion of the periphery of the window 44. As such, the window seat 26 may “frame” the outside periphery of the window 44. In some examples, the window seat 26 may surround all of the periphery of the window 44. For example, the window 44 may be shaped as a rectangle with four peripheral edges defining the rectangle (i.e., the top edge, the bottom edge, the left-side edge, and the right-side edge). In such an example, the window seat 26 (or a combination of window seats 26) may surround all of the periphery of the window 44 when the window seat 26 (or a combination of window seats 36) entirely surrounds each of the top edge, the bottom edge, the left-side edge, and the right-side edge. In other examples, the window seat 26 (or a combination of window seats 26) may surround only a portion of the periphery of the window 44. As an example of this, when the window 44 is shaped as a rectangle with four peripheral edges defining the rectangle shape, the window seat 26 (or a combination of window seats 26) may only partially surround the rectangular shape (e.g., one or more, or a portion of one or more, of the top edge, the bottom edge, the left-side edge, and/or the right-side edge of the window 44 may not be surrounded). As an example of this, the window 44 may be part of a sea wall, where the window seat 26 (or a combination of window seats 26) may surround the bottom edge, the left-side edge, and the right-side edge of the window 44 (but may not surround the top edge of the window 44).

As is illustrated in FIG. 1B, the window seat 26 may have a seat portion 27 and a support portion 28. The seat portion 27 may be the portion of the window seat 26 (or a portion of a combination of window seats 26) that surrounds all or a portion of the periphery of the window 44. The seat portion 27 may have a depth that extends into depth of the opening 14 of the structure 18 (e.g., in FIG. 1B, the seat portion 27 extends horizontally into the opening 14 of the structure 18).

The seat portion 27 may include an assembly angle chase 29 positioned at a distal end of the seat portion 27 (e.g., positioned at the right-most end of the seat portion 27 in FIG. 1B). The assembly angle chase 29 may provide a ledge that may catch any water that may enter the frame 22. This may prevent water from flowing into the structure 18. As is discussed further below, the assembly angle chase 29 may further assist in coupling the cap 34 to other portions of the frame 22. As is illustrated, the assembly angle chase 29 may be angular, and may include a vertical portion and a horizontal portion. These portions may create a ledge-like structure that can catch water.

The support portion 28 of the window seat 26 may be a portion of the window seat 26 that extends outward from the seat portion 27. As is illustrated in FIG. 1B, this may allow the support portion 28 to extend past the periphery of the window 44 and cover a portion of the front-side of the window 44. By covering the front-side of the window 44, the support portion 28 may provide support to the window 44, and may prevent the window 44 from moving past the support portion 28. As such, the support portion 28 may assist in holding the window 44 in place. The support portion 28 may extend outward from the seat portion 27 by any amount, thereby allowing the support portion 28 to cover any amount of the front-side of the window 44. The support portion 28 may also extend outward from the seat portion 27 at any angle. As is illustrated in FIG. 1B, the support portion 28 may extend outward from the seat portion 27 at a 90° angle, causing the support portion 28 to be positioned perpendicular to the seat portion 27.

The window seat 26 (and the seat portion 27 and the support portion 28) may have any size and/or shape. Additionally, the window seat 26 (and the seat portion 27 and the support portion 28) may be made of any suitable material. As an example, the window seat 26 (and the seat portion 27 and the support portion 28) may be made of aluminum (e.g., extruded aluminum), steel (e.g., stainless steel), any other suitable material, or any combination of the preceding.

The frame 22 may further include the window stop 30. The window stop 30 may be a moveable structure that can assist in holding the window 44 in place. By holding the window 44 in place, the window stop 30 may prevent the window 44 from moving inward into the structure 18 (e.g., it may prevent the window 44 from moving to the right in FIG. 1B). As a result, the window stop 30 and the support portion 28 may work together, with the window stop 30 preventing the window 44 from moving inward into the structure 18, and the support portion 28 preventing the window 44 from moving outward out of the opening 14 of the structure 18 (e.g., it may prevent the window 44 from moving to the left in FIG. 1B).

As is illustrated in FIG. 1B, the window stop 30 may have an anchor portion 31 and a stop portion 32. The anchor portion 31 may be a portion of the window stop 30 that can be coupled to the window seat 26, so as to hold the window stop 30 in place. This coupling may keep the window stop 30 from moving. To assist in coupling the anchor portion 31 to the window seat 26, the anchor portion 31 may have one or more teeth 33 that extend outward from the anchor portion 31 towards the window seat 26. Each of these teeth 33 may be positioned within a corresponding pocket 39 in the seat portion 27 of the window seat 26. When positioned within the pockets 39, the teeth 33 may help hold the window stop 30 in place. For example, when the teeth 33 are positioned within the pockets 39, they may work together to hold the window stop 30 in place during an impact event (e.g., a flood event) that has a force of up to a load of 10 feet of water or more (e.g., an impact of 4,000 pounds or more).

The stop portion 32 may be a portion of the window stop 30 that extends outward from the anchor portion 31 towards the window 44. As is illustrated in FIG. 1B, this may allow the stop portion 32 to extend past the periphery of the window 44 and cover a portion of the back-side of the window 44. By covering a portion of the back-side of the window 44, the stop portion 32 may provide support to the window 44, and may prevent the window 44 from moving past the stop portion 32. As such, the stop portion 32 may assist in holding the window 44 in place. The stop portion 32 (of the window stop 30) and the support portion 28 (of the window seat 26) may work together, with the stop portion 32 preventing the window 44 from moving inward into the structure 18 (e.g., it may prevent the window 44 from moving to the right in FIG. 1B), and with the support portion 28 preventing the window 44 from moving outward out of the opening 14 of the structure 18 (e.g., it may prevent the window 44 from moving to the left in FIG. 1B).

The stop portion 32 may extend outward from the anchor portion 31 by any amount, thereby allowing the stop portion 32 to cover any amount of the back-side of the window 44. The stop portion 32 may also extend outward from the anchor portion 31 at any angle. As is illustrated in FIG. 1B, the stop portion 32 may extend outward from the anchor portion 31 at a 90° angle, causing the stop portion 32 to be positioned perpendicular to the anchor portion 31.

As is discussed above, the window stop 30 may be a moveable structure that can assist in holding the window 44 in place. This means that the window stop 30 may be moved inward into the opening 14 of the structure (e.g., to the right in FIG. 1B) and/or outward (e.g., to the left in FIG. 1B). This may allow the window stop 30 (and the window seat 26) to hold a window 44 having any thickness. For example, if the window 44 is a thin window, the window stop 30 may be moved outward (e.g., moved to the left in FIG. 1B) so that it can assist in holding the thinner window in place. Alternatively, if the window 44 is a thick window, the window stop 30 may be moved inward (e.g., moved to the right in FIG. 1B) so that it can assist in holding the thicker window in place. After the window stop 30 is moved to a particular position (so that it can hold a particular window 44 have a particular thickness), the teeth 33 of the window stop 30 may be positioned within the pockets 39 of the window seat 26, thereby holding the window stop 30 in place at that position.

To assist in the movement and positioning of the window stop 30, the teeth 33 may be evenly spaced from each other (e.g., they may have the same amount of space between each adjacent tooth 33) and the pockets 39 may also be evenly spaced from each other (e.g., they may have the same amount of space between each adjacent pocket 39). Furthermore, the spacing between each adjacent tooth 33 and the spacing between each adjacent pocket 39 may be the same. This may allow any of the teeth 33 to be positioned in any of the pockets 39, which may allow the window stop 30 to be more easily moved inward or outward, as is discussed above. In some examples, one or more of the teeth 33 may be removable (e.g., they may be cut off). In such an example, if the window stop 30 is moved to a position where one or more of the teeth 33 may not fit into a corresponding pocket 39, the teeth 33 without a corresponding pocket 39 may be removed.

The movability of the window stop 30 may also include the ability to remove (e.g., cut off) portions of the window stop 30. For example, if the window stop 30 is moved inward to a position where the distal end of the anchor portion 32 (e.g., the right-most end of the anchor portion 32 in FIG. 1B) would be blocked (or would collide) with the assembly angle chase 29, a section of the anchor portion 32 may be removed from the anchor portion 32. This may allow the window stop 30 to be moved to any position along the window seat 26 without interfering with other portions of the window seat 26.

The window stop 30 (and the anchor portion 31 and the stop portion 32) may have any size and/or shape. Additionally, the window stop 30 (and the anchor portion 31 and the stop portion 32) may be made of any suitable material. As an example, the window stop 30 (and the anchor portion 31 and the stop portion 32) may be made of aluminum (e.g., extruded aluminum), steel (e.g., stainless steel), any other suitable material, or any combination of the preceding.

The frame 22 may further include the cap 34. The cap 34 may be an adjustable structure that covers one or more exposed portions of the window seat 26 and the window stop 30. This covering may prevent dust and debris from falling into or on the window seat 26 and/or into or on the window stop 30. It may also provide a more aesthetically pleasing look. In some examples, the cap 34 may also cover one or more exposed portions of the connection system 72. This may prevent the connection system 72 from being interfered with. It may also help prevent the connection system 72 from being accidentally uncoupled or loosened.

As is illustrated in FIG. 1B, the cap 34 may have a stop cover portion 35 and a seat cover portion 36. The stop cover portion 35 may be portion of the cap 34 that may extend over and cover the exposed portions of the window stop 30. To cover these exposed portions, the stop cover portion 35 may extend inward from the window 44 to a location positioned further inward of the window stop 30 and the window seat 26 (e.g., it may extend towards the right in FIG. 1B).

The seat cover portion 36 may be a portion of the cap 34 that may extend over and cover the exposed portions of the window seat 26 and the exposed gap in-between the window seat 26 and the structure 18. To cover these exposed portions, the seat cover portion 36 may extend outward from stop cover portion 35 towards the periphery of the opening 14 in the structure 18 (e.g., it may extend upwards or downwards in FIG. 1B). The seat cover portion 36 may extend outward from the stop cover portion 35 by any amount. In some examples, it may extend all the way to the periphery of the opening 14 in the structure 18, causing it to touch the structure 18 (as is seen in FIG. 1B). The seat cover portion 36 may also extend outward from the stop cover portion 35 at any angle. As is illustrated in FIG. 1B, the seat cover portion 36 may extend outward from the stop cover portion 35 at a 90° angle, causing the seat cover portion 36 to be positioned perpendicular to the stop cover portion 35.

The cap 34 may be coupled to the window stop 30, so as to allow the cap 34 to cover the exposed portions of the window stop 30 and the window seat 26. To couple the cap 34 to the window stop 30, the stop cover portion 35 may include one or more teeth 37 that extend outward from the stop cover portion 35 towards the window stop 30. One of these teeth 37 may be positioned within a forked anchor 38 of the window stop 30. When positioned within the forked anchor 38, the tooth 37 may hold the cap 34 in place. In some examples, the teeth 37 and the forked anchor 38 may include ridges, as is illustrated in FIG. 1B. These ridges may help keep the tooth 37 positioned within the forked anchor 38.

The cap 34 may also be coupled to the window seat 26. To couple the cap 34 to the window seat 26, the seat cover portion 36 may include a protrusion 40. In operation, the protrusion 40 of the seat cover portion 36 may be positioned against the assembly angle chase 29 included on the window seat 26. As is illustrated in FIG. 1B, the protrusion 40 may be an angular protrusion that may allow the protrusion 40 to be positioned against the horizontal portion of the assembly angle chase 29, and that may further allow the protrusion 40 to extend past the horizontal portion of the assembly angle chase 29 (e.g., extend vertically downward or upward past the horizontal portion of the assembly angle chase 29) towards the seat portion 27 of the window seat 26. As is illustrated in FIG. 1B, this may cause the protrusion 40 to hook around the assembly chase angle 29, coupling the cap 34 to the window seat 26. In addition, the protrusion 40 may further be sandwiched in a gap in-between the assembly angle chase 29 and the distal end of the window stop 30, as is also illustrated in FIG. 1B. This may provide a further coupling.

As is discussed above, the cap 34 may be an adjustable structure. This adjustability may assist in allowing the cap 34 to be used with the moveable window stop 30 (discussed above). In some examples, the cap 34 may be adjustable as a result of having more than one tooth 37. For example, as is seen in FIG. 1B, the cap 34 has four teeth 37a-d. In the illustrated example, the first tooth 37a may be positioned within the forked anchor 38 of the window stop 30, so as to hold the cap 34 in place. However, in other examples, the thickness of the window 44 may result in the window stop 30 being moved inward (moved to the right in FIG. 1B) so that the window stop 30 can assist in holding the thicker window 44 in place. In such an example, the second tooth 37b (or the third tooth 37c or the fourth tooth 37d) may be positioned within the forked anchor 38 of the window stop 30, so as to hold the cap 34 in place. That is, as the window stop 30 is moved, the tooth 37 that is used to hold the cap 34 in place, may change. Furthermore, in some examples, each of the teeth 37 may be evenly spaced from each other (e.g., they may have the same amount of space between each adjacent tooth 33), and this spacing may be the same as (i.e., match) the spacing in-between the teeth 33 of the window stop 30 and the space in-between the pockets 39 of the window seat 26. As such, if the window stop 30 is moved inward by one tooth 33 and pocket 39, that movement will result in the forked anchor 38 being positioned at a location that allows the second tooth 37b to line up (and be positioned within) the forked anchor 38.

Additionally, the adjustability of the cap 34 may also include the ability to remove (e.g., cut off) portions of the stop cover portion 35. For example, if the second tooth 37b is going to be positioned within the forked anchor 38 (instead of the first tooth 37a), the first tooth 37a (and its corresponding section of the stop cover portion 35) may be removed from the stop cover portion 35. This may allow the cap 34 to be used with the frame 22 without interfering with the window 44, in some examples.

The cap 34 (and the stop cover portion 35 and the seat cover portion 36) may have any size and/or shape. Additionally, the cap 34 (and the stop cover portion 35 and the seat cover portion 36) may be made of any suitable material. As an example, the cap 34 (and the stop cover portion 35 and the seat cover portion 36) may be made of aluminum (e.g., extruded aluminum), steel (e.g., stainless steel), any other suitable material, or any combination of the preceding.

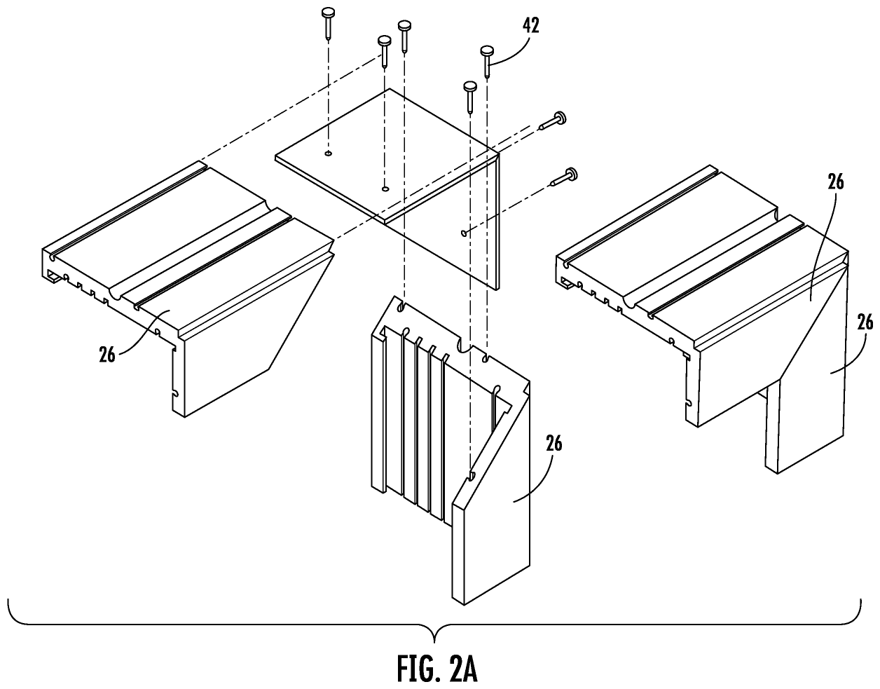

The frame 22 may include any number of window seats 26, window stops 30, and caps 34. For example, if the frame 22 is surrounding the entire periphery of a rectangle window 44, the frame 22 may include four window seats 26, four window stops 30, and four caps 34 (with one window seat 26, one window stop 30, and one cap 34 for each of the top edge, the bottom edge, the left-side edge, and the right-side edge of the rectangular window 44). FIGS. 2A and 2B illustrate examples of the coupling of two window seats 26 together at a corner of the window 44. To couple a window seat 26 to another window seat 26 (as is seen in FIGS. 2A-2B), and/or to couple a cap 34 to another cap 34, the window seat 26 and/or cap 34 may include various connector chases 41. These connector chases 41 may receive one or more frame connectors 42 (e.g., where a frame connector 42 may be a screw, a bolt, any other connector, or any combination of the preceding), and the frame connectors 42 may couple the window seat 26 to another window seat 26 (or couple a cap 34 to another cap 34).

As is illustrated in FIG. 1B, the flood barrier window system 10 further includes the window 44. The window 44 may be a transparent (or semi-transparent) barrier. The window 44 may be made of any material(s) that allow it to be a transparent (or semi-transparent) barrier. For example, the window 44 may be made of glass, which may allow a user to view the environment outside (and/or inside) of the structure 18. Furthermore, although the window 44 may be made of glass, the window 44 may provide protection against a flood event. For example, the window 44 may provide protection against a flood event that has a force of up to a load of 10 feet of water or more (e.g., an impact of 4,000 pounds or more).

The window 44 may have any shape. For example, the window may be shaped as a square window, a rectangular window, a circular window, an oval window, any other shaped window, or any combination of the preceding. As is illustrated in FIG. 1A, the window 44 is shaped as a rectangular window 44. The window 44 may also have any size. For example, the window 44 may have a size of 2×2 feet, 11×20 feet, 12×39 feet, any size in-between 2×2 and 12×39 feet, or any other size.

The window 44 may include a first window portion 48, a second window portion 52, and an interlayer 56 positioned in-between the first window portion 48 and the second window portion 52. The first window portion 48 and the second window portion 52 may each have the same shape and size as the window 44, in some examples. In other examples, the first window portion 48 and the second window portion 52 may each have a different shape and/or size. Additionally, the first window portion 48 and the second window portion 52 may each have any thickness. For example, as is illustrated, the first window portion 48 and the second window portion 52 may each be 0.5 inches thick. In some examples, the first window portion 48 and the second window portion 52 may each have the same thickness, and in other examples, the first window portion 48 and the second window portion 52 may each have a different thickness.

The first window portion 48 and the second window portion 52 may each be made of any material that provides a transparent (or semi-transparent) barrier. For example, the first window portion 48 and the second window portion 52 may each be made of glass. In some examples, the first window portion 48 and the second window portion 52 may each be made of heat strengthened glass. In other examples, the first window portion 48 and the second window portion 52 may each be made of tempered glass.

The interlayer 56 may bond or laminate the first window portion 48 and/or the second window portion 52 together. This may hold the first window portion 48 and/or the second window portion 52 in place, even if the first window portion 48 and/or the second window portion 52 is broken. The window 44 may include one layer of interlayer 56, or may include more than one layer of interlayer 56, such as two layers of interlayer 56, three layers of interlayer 56, or any other number of layers. The interlayer 56 may have a high strength that prevents the first window portion 48 and/or the second window portion 52 from breaking up into large sharp pieces, in some examples.

The interlayer 56 may be made of any material that bonds or laminates the first window portion 48 and/or the second window portion 52 together. For example, the interlayer 56 may be made of polyvinyl butyral (PVB), ethylene-vinyl acetate (EVA), an ionoplast polymer, KEVLAR, any other material that bonds the first window portion 48 and/or the second window portion 52 together, or any combination of the preceding. One example of interlayer 56 is SENTRYGLAS ionoplast interlayer made by Kuraray America, Inc. Another example of interlayer 57 may include SENTRYGLAS ionoplast interlayer attached to a KEVLAR membrane. In some examples, the interlayer 56 may be water resistant. In such examples, the interlayer 56 may provide additional protection from water leakages. For example, if one of the first window portion 48 or the second window portion 52 were to break or crack, the interlayer 56 may provide a barrier that prevents the water from leaking through the entirety of the window 44, in some examples. As such, the interlayer may provide further flood event protection.

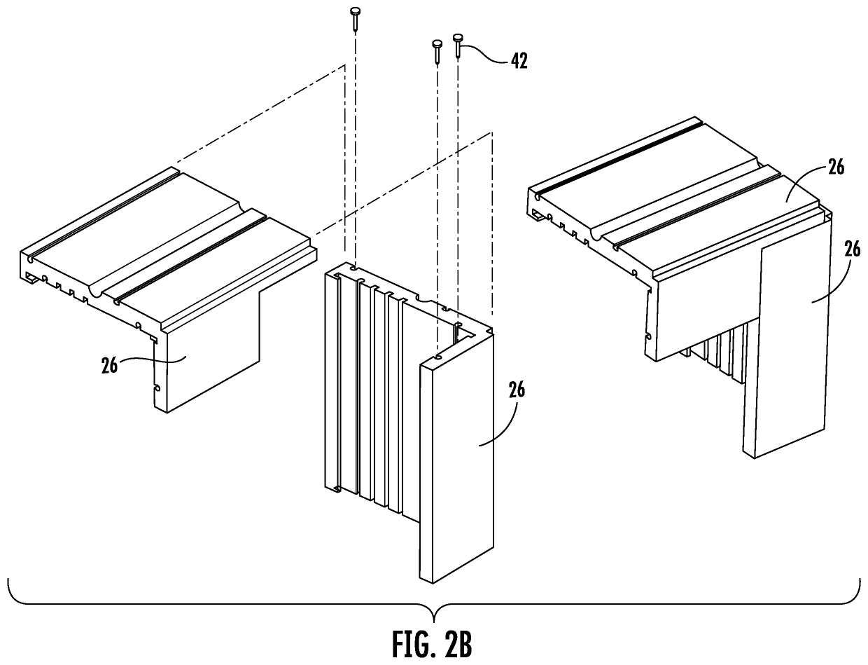

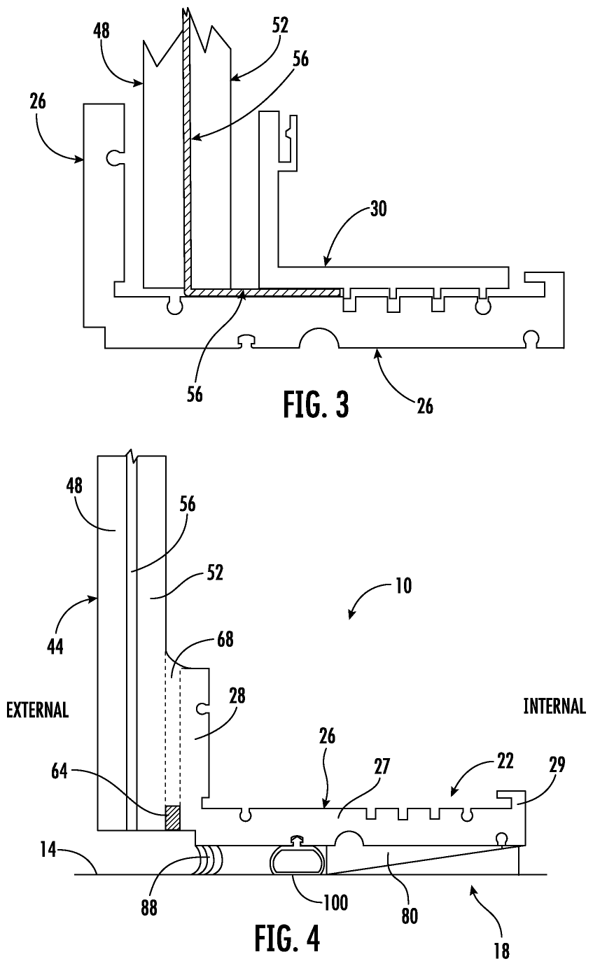

The interlayer 56 may have any shape and/or size. For examples, the interlayer 56 may have any thickness. As is illustrated, the interlayer 56 may have a thickness of 0.180 inches. As another example, the interlayer 56 may have a length and/or width that allows it to cover the entire surface area (or substantially all of the surface area) in-between the first window portion 48 and the second window portion 52. In other examples, the interlayer 56 may have a length and/or width that is greater than the surface area in-between the first window portion 48 and the second window portion 52. This may allow the interlayer 56 to extend out of the periphery of the window 44. In some examples, the interlayer 56 may extend out of the periphery of the window 44 and further extend into the frame 22. For example, the interlayer 56 may extend out of the periphery of the window 44 and further extend in-between the window stop 30 and the window seat 26. An example of this is illustrated in FIG. 3. By extending out of the periphery of the window 44 and extending in-between the window stop 30 and the window seat 26, the window stop 30 and the window seat 26 may secure the interlayer 56 to the frame 22, in some examples. Additionally, by extending out of the periphery of the window 44 and extending in-between the window stop 30 and the window seat 26, the interlayer 56 may provide a water resistant layer in-between the window stop 30 and the window seat 26, in some examples. This water resistant layer may provide further flood event protection by assisting in water proofing the frame 22. For example, it may prevent water from leaking inward of the window 44 (e.g., to the left in FIG. 3).

When the window 44 is installed in the frame 22 (as is illustrated in FIG. 1B), the flood barrier window system 10 may include additional components. For example, the flood barrier window system 10 may include a setting block 60, glazing tape 64, and sealant 68.

The setting block 60 may protect the window 44 from impact and/or may provide stress relief as the window 44 expands and contracts with changing temperatures. The setting block 60 may be positioned in-between the periphery of the window 44 and the window seat 26, as is illustrated in FIG. 1B.

The glazing tape 64 may create a seal in-between the setting block 60, the window 44, and the window seat 26. This seal may prevent wind and/or water from moving past the glazing tape 64 and further into the frame 22.

The sealant 68 may provide an additional seal for the window 44 and frame 22, so as to prevent wind and/or water from entering the frame 22. The sealant 86 may also help hold the window 44 in place in-between the window seat 26 and the window stop 30. The sealant 68 may be applied in-between the support portion 28 (of the window seat 26) and the first window portion 48 (as is illustrated in FIG. 1B), and/or may be applied in-between the stop portion 32 (of the window stop 30) and the second window portion 52 (as is also illustrated in FIG. 1B). The sealant 68 may be a silicone sealant. One example of sealant 68 is SPECTREM 2 by Tremco Inc. As is illustrated, when the sealant 86 is applied, it may flow into one or more unused connector chases 41. As such, the sealant 86 and connector chase 41 may work together to further hold the window 44 in place in-between the window seat 26 and the window stop 30, in some examples.

As is also illustrated in FIG. 1B, the flood barrier window system 10 further includes the connection system 72. The connection system 72 may hold the frame 22 and the window 44 within the opening 14 of the structure 18, and may further provide a barrier against one or more elements along a periphery of the frame 22 (e.g., it may provide a barrier in the gap in-between the frame 22 and the structure 18).

The connection system 72 may include connectors 76 that hold the frame 22 and the window 44 within the opening 14 of the structure 18. The connector 76 may be a screw, a bolt, any other connector that holds the frame 22 and the window 44 within the opening 14 of the structure 18, or any combination of the preceding. As is illustrated, the connectors 76 are screws. The screws may be positioned (or screwed) through the window stop 30, through the window seat 26, and into the structure 18 (e.g., into a C7 steel channel in the building). As such, the screws may secure the frame 22 (e.g., the window stop 30, the window seat 26, and any other portion of the frame 22) and the window 44 to the structure 18. Any number of connectors 76 may be used to hold the frame 22 and the window 44 within the opening 14 of the structure 18. Furthermore, as is illustrated, the cap 34 may cover the exposed portions of the connectors 76, which may help prevent them from being accidentally loosened and/or dislodged.

The connection system 72 may further include shims 80. The shim 80 may wedge the frame 22 and window 44 in place within the framing of the opening 14 of the structure 18. The shim 80 may have any size. For example, the shim 80 may have a size of ⅜ inches to ½ inches. The shim 80 may be made of wood, plastic, metal, any other suitable material, or any combination of the preceding. Any number of shims 80 may be used to wedge the frame 22 and window 44 in place within the framing of the opening 14 of the structure 18.

The connection system 72 may further include a water sealant system 84 that may prevent water (or reduce the amount of water) that may enter the gap in-between the frame 22 and the structure 18. As is illustrated, the water sealant system 84 may include a first level of sealant 88 applied in a location outward (e.g., to the left in FIG. 1B) of a backer rod 92. The first level of sealant 88 may be any type of sealant. For example, the first level of sealant 88 may be a silicone sealant. One example of the first level of sealant 88 is SPECTREM 2 by Tremco Inc. The backer rod 92 may be a structure that creates a back stop for sealant. For example, in FIG. 1B, the backer rod 92 creates a back stop for the first level of sealant 88. The backer rod 92 may have any shape (e.g., round, cylinder), and may be made of any material (e.g., foam).

The water sealant system 84 may further include a second level of sealant 96 applied in a location inward (e.g., to the right in FIG. 1B) of the backer rod 92. The second level of sealant 96 may be any type of sealant. For example, the second level of sealant 96 may be a silicone sealant. One example of the second level of sealant 96 is SPECTREM 2 by Tremco Inc. Traditionally, a sealant is not applied in a location inward of a backer rod. The reason for this is that sealants are susceptible to failure due to three point adhesion. A backer rod is traditionally used inward of the sealant so as to prevent this three point adhesion. In contrast to this, the water sealant system 84 may include a gasket 100 positioned in a location inward (e.g., to the right in FIG. 1B) of the second level of sealant 96. This gasket 100 may, in some examples, prevent three point adhesion in the second level of sealant 96. As such, unlike traditional systems, the water sealant system 84 can include two levels of sealant, as opposed to just one. This additional level of sealant may provide further water protection by further preventing water (or further reducing the amount of water) that may enter the gap in-between the frame 22 and the structure 18.

The water sealant system 84 may further include the gasket 100. The gasket 100 may provide an additional seal within the gap in-between the frame 22 and the structure 18. Additionally, it may also prevent three point adhesion from occurring in the second level of sealant 96. The gasket 100 may have any shape and/or size. As is illustrated, the gasket 100 may be originally shaped as a ball (or have a circular or spherical shape). When the frame 22 and the window 44 are installed in the opening 14 in the structure 18, the ball shape of the gasket 100 may be squished in-between the structure 18 and the frame 22, changing the shape of the gasket 100 (as is seen in FIG. 1B). This may seal off the gap in-between the frame 22 and the structure 18, which may create the additional seal.

The shape of the gasket 100 may, in some examples, assist in the installation of the gasket 100. For example, the gasket 100 may include a nodule 101 that may extend out of the gasket 100. This nodule 101 may be positioned within a gasket pocket 102 included in the window seat 26. When the nodule 101 is positioned within the gasket pocket 102, the gasket 100 may be coupled to the window seat 26, allowing for the gasket 100 to remain in place when the frame 22 is positioned within the opening 14 of the structure 18.

The gasket 100 may be made of any material that may allow it to provide an additional seal within the gap in-between the frame 22 and the structure 18, and that may further allow it to prevent three point adhesion from occurring in the second level of sealant 96. As one example of this, the gasket 100 may be made of silicone.

As is discussed above, the water sealant system 84 may include (1) the first level of sealant 88, (2) the second level of sealant 96, and (3) the gasket 100. This combination provides three separate levels of protection against water (and other elements). Traditionally, window systems may only include a single level of protection against water, such as only a single level of sealant. In contrast, the flood barrier window system 10 (and the water sealant system 84) may include three levels of protection against water (and other elements). This use of three levels (as opposed to just one) may provide better protection during a flood event.

Furthermore, in some examples, the gasket 100 may be replaced with an additional gasket rod 92. That is, the water sealant system 84 may include a first backer rod 92 and a second backer rod 92, and may further include the first level of sealant 88 positioned in a location outward (e.g., to the left in FIG. 1B) of the first backer rod 92, and the second level of sealant 96 positioned in a location inward (e.g., to the right in FIG. 1B) of the first backer rod 92 and further positioned in a location outward (e.g., to the left in FIG. 1B) of the second backer rod 92. An example of this is illustrated in FIGS. 7-19. In other examples, the gasket 100 may be replaced with a foam structure, such as EXOAIR Flex Foam by Tremco Inc.

FIG. 4 illustrates another example of a flood barrier window system 10. Flood barrier window system 10 of FIG. 4 (and its components) may be substantially similar to flood barrier window system 10 of FIGS. 1A-C (and its components). However, as is illustrated, the flood barrier window system 10 of FIG. 4 may not include the window stop 30 or the cap 34. Instead, in the example of FIG. 4, an interior-facing surface (e.g., facing towards the right in FIG. 4) of the window 44 may be coupled to an exterior-facing surface (e.g., facing towards the left in FIG. 4) of the support portion 28 of the window seat 26. Additionally, although the flood barrier window system 10 of FIG. 4 is illustrated as not including connectors 76, the flood barrier window system 10 of FIG. 4 may include such connectors 76 to hold the frame 22 (and the window 44) within the opening 14 of the structure 18.

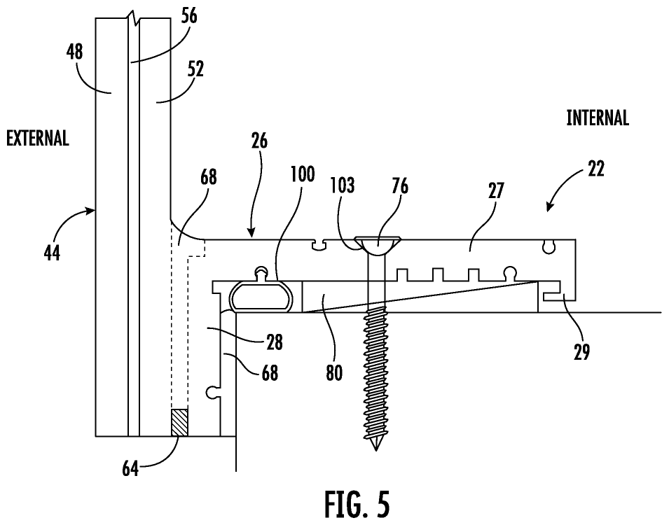

FIG. 5 illustrates another example of a flood barrier window system 10. Flood barrier window system 10 of FIG. 5 (and its components) may be substantially similar to flood barrier window system 10 of FIG. 4 (and its components). However, as is illustrated, the window seat 26 of FIG. 5 may be installed in a configuration that is a mirror image of that in FIG. 4. Furthermore, in this configuration, the window seat 26 may include a depression 103 that may be used as a countersink for the connectors 76. In other configurations (such as those in FIGS. 1A-1C and FIG. 4), this depression 103 may be used as spacing for the backer rod 92.

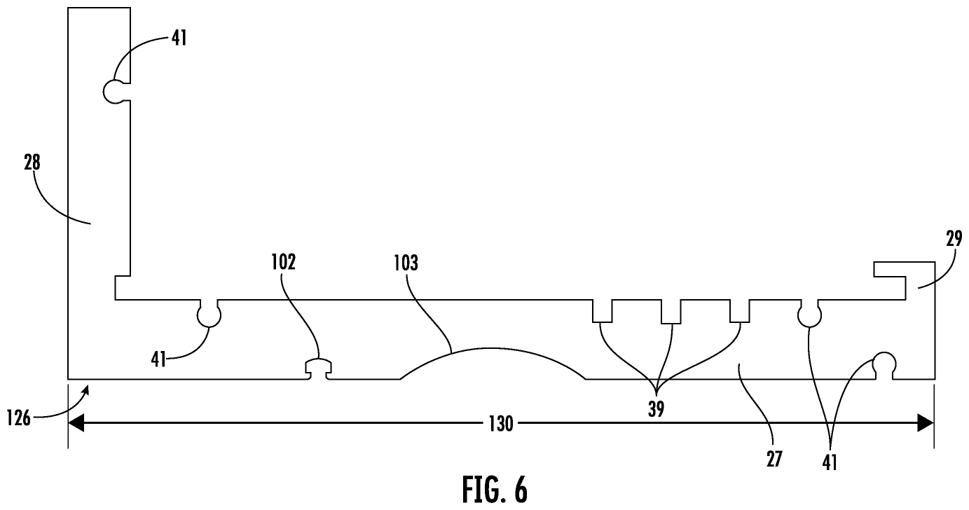

FIG. 6 illustrates a cross-sectional view of another example of a window seat 126 of a flood barrier window system 10. The window seat 126 of FIG. 6 may be substantially similar to the window seat 26 discussed above. However, the window seat 126 (and the seat portion 27 and the support portion 28) may have a different size than the window seat 26 described above, in some examples. For example, the window seat 126 may have a larger length 130. As one example of this, the window seat 126 may have a length 130 of 7 inches, while the window seat 26 may have a length 130 of 6 inches. Furthermore, the window seat 126 may not include a notch (in the front portion of the length 130) that is included in window seat 26. Additionally, the window seat 126 may have a larger depression 103. The window seat 126 of FIG. 6 may be utilized in any of the examples described herein (instead of window seat 26). Alternatively, the window seat 26 may be utilized in any of the examples below (instead of window seat 126).

FIG. 7 illustrates another example of a flood barrier window system 10. Flood barrier window system 10 of FIG. 7 (and its components) may be substantially similar to flood barrier window system 10 of FIG. 4 (and its components). However, as is illustrated, the flood barrier window system 10 of FIG. 7 includes an interlayer 56 that extends out of the periphery of the window 44 and wraps around all (or a portion) of the periphery of second window portion 52. In some examples, by wrapping around all (or a portion) of the periphery of the second window portion 52, the interlayer 56 may provide an additional water barrier along the periphery of the second window portion 52, which may prevent (or help reduce) water from leaking above and/or below this periphery. The interlayer 56 may be coupled to the periphery of second window portion 52 using any adhesive (e.g., glue). As is also illustrated in FIG. 7, the flood barrier window system 10 includes window seat 126, further includes two breaker rods 92 (as is discussed above), and also includes glazing tape 64 in-between the second window portion 52 and the window seat 126.

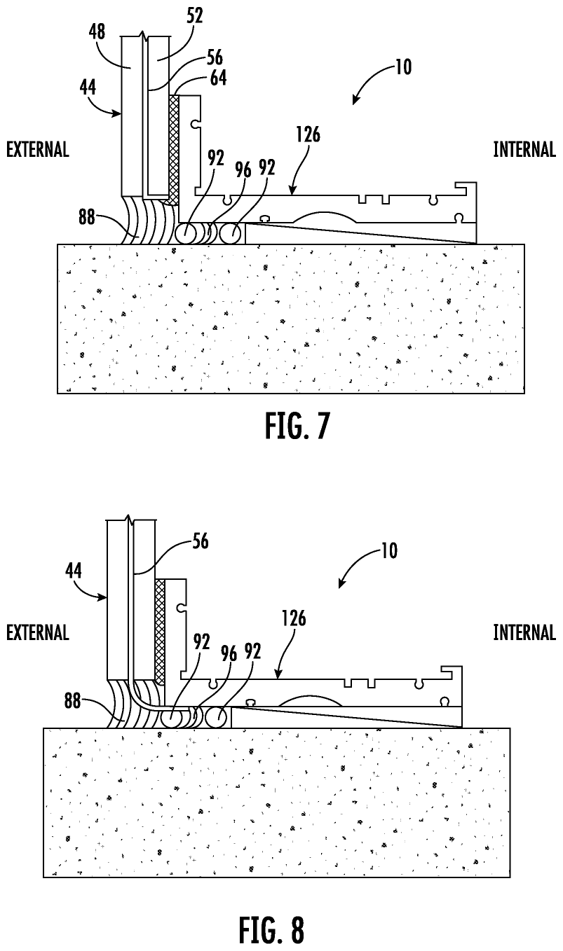

FIG. 8 illustrates another example of a flood barrier window system 10. Flood barrier window system 10 of FIG. 8 (and its components) may be substantially similar to flood barrier window system 10 of FIG. 7 (and its components). However, as is illustrated, the flood barrier window system 10 of FIG. 8 includes an interlayer 56 that extends out of the periphery of the window 44 and extends underneath the bottom of window seat 126 (i.e., it extends in-between the window seat 126 and the structure 18). In some examples, by extending underneath the bottom of window seat 126, the interlayer 56 may provide an additional water barrier that extends from the window 44 to the window seat 126, which may prevent (or help reduce) water from leaking above and/or below this area. The interlayer 56 may be coupled to the bottom of the window seat 126 using any adhesive (e.g., glue).

FIG. 9 illustrates another example of a flood barrier window system 10. Flood barrier window system 10 of FIG. 9 (and its components) may be substantially similar to flood barrier window system 10 of FIG. 7 (and its components). However, as is illustrated, the flood barrier window system 10 of FIG. 9 includes an interlayer 56 that extends out of the periphery of the window 44, wraps around all (or a portion) of the periphery of second window portion 52, further wraps around the back-side of the second window portion 52, and extends vertically (e.g., upward) along a portion of the back-side of the second window portion 52. In some examples, this may allow the interlayer 56 to provide an additional water barrier along these areas, which may prevent (or help reduce) water from leaking above and/or below these areas. The interlayer 56 may be coupled to the periphery of the second window portion 52 and the portion of the back-side of the second window portion 52 using any adhesive (e.g., glue).

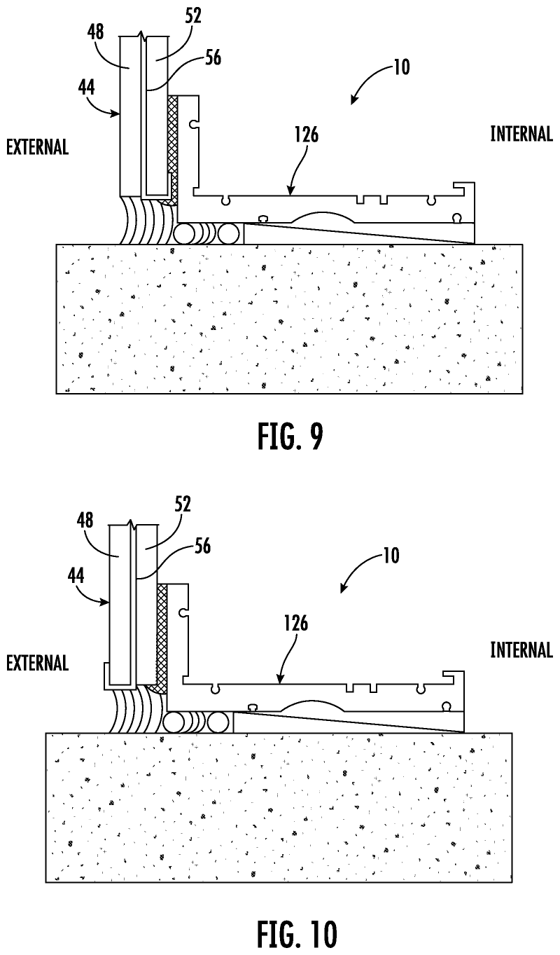

FIG. 10 illustrates another example of a flood barrier window system 10. Flood barrier window system 10 of FIG. 10 (and its components) may be substantially similar to flood barrier window system 10 of FIG. 7 (and its components). However, as is illustrated, the flood barrier window system 10 of FIG. 10 includes an interlayer 56 that extends out of the periphery of the window 44, wraps around all (or a portion) of the periphery of the first window portion 48, further wraps around the front-side of the first window portion 48, and extends vertically (e.g., upward) along a portion of the front-side of the first window portion 48. In some examples, this may allow the interlayer 56 to provide an additional water barrier along these areas, which may prevent (or help reduce) water from leaking above and/or below these areas. The interlayer 56 may be coupled to the periphery of the first window portion 48 and the portion of the front-side of the first window portion 48 using any adhesive (e.g., glue).

FIG. 11 illustrates another example of a flood barrier window system 10. Flood barrier window system 10 of FIG. 11 (and its components) may be substantially similar to flood barrier window system 10 of FIG. 9 (and its components). However, as is illustrated, the flood barrier window system 10 of FIG. 11 includes a shelf 134 coupled to the window seat 126. The shelf 134 is a structure (e.g., aluminum structure) that may provide additional support for heavier windows 44, in some examples. The shelf 134 may be coupled to the window seat 126 in any manner (e.g., welding). The flood barrier window system 10 of FIG. 11 further includes a setting block 60 that may protect the window 44 from impact and/or may provide stress relief as the window 44 expands and contracts with changing temperatures. The flood barrier window system 10 of FIG. 11 may also include additional sealant 86 in-between the shelf 134 and the window 44.

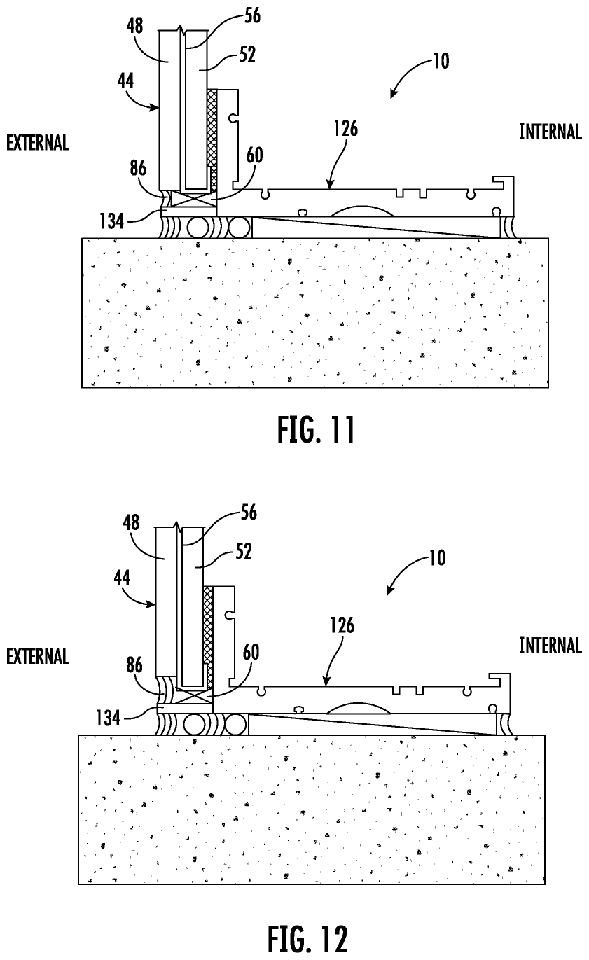

FIG. 12 illustrates another example of a flood barrier window system 10. Flood barrier window system 10 of FIG. 12 (and its components) may be substantially similar to flood barrier window system 10 of FIG. 11 (and its components). However, as is illustrated, the flood barrier window system 10 of FIG. 12 includes a window 44 having a first window portion 48 that is shorter in length than a second window portion 52. This may result in an extended interlayer 56, in some examples. The first window portion 48 may be shorter in length by any amount.

FIG. 13 illustrates another example of a flood barrier window system 10. Flood barrier window system 10 of FIG. 13 (and its components) may be substantially similar to flood barrier window system 10 of FIGS. 1A-C and 3 (and its components). For example, as is illustrated, the interlayer 56 extends out of the periphery of the window 44 and further extends in-between the window stop 30 and the window seat 26. In some examples, this may allow the interlayer 56 to provide an additional water barrier along these areas, which may prevent (or help reduce) water from leaking above and/or below these areas. However, unlike FIG. 3, the flood barrier window system 10 of FIG. 13 includes a setting block 60 (as is discussed above), and further includes two breaker rods 92 (as is also discussed above).

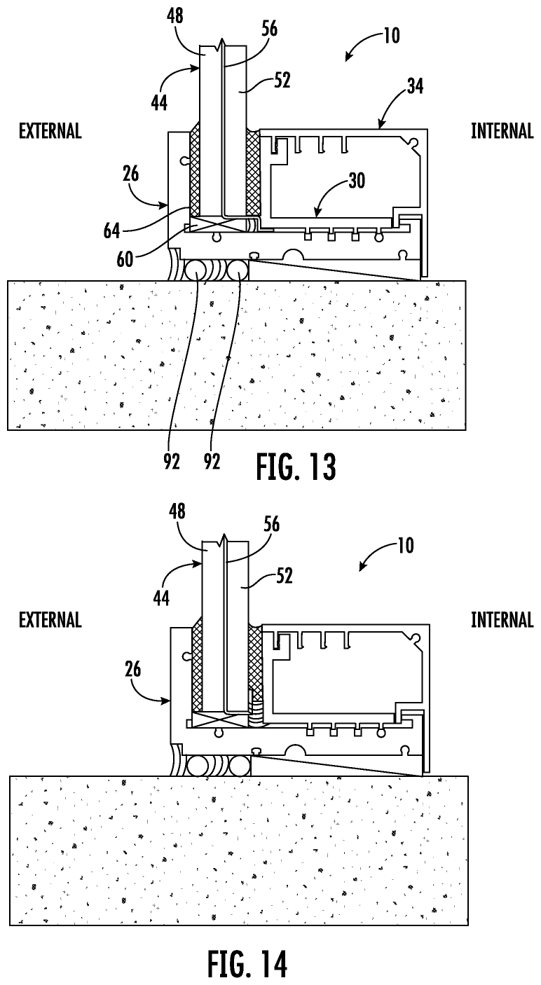

FIG. 14 illustrates another example of a flood barrier window system 10. Flood barrier window system 10 of FIG. 14 (and its components) may be substantially similar to flood barrier window system 10 of FIG. 13 (and its components). However, as is illustrated, the flood barrier window system 10 of FIG. 14 includes an interlayer 56 that extends out of the periphery of the window 44, wraps around all (or a portion) of the periphery of the second window portion 52, further wraps around the back-side of the second window portion 52, and extends vertically (e.g., upward) along a portion of the back-side of the second window portion 52. In some examples, this may allow the interlayer 56 to provide an additional water barrier along these areas, which may prevent (or help reduce) water from leaking above and/or below these areas. The interlayer 56 may be coupled to the periphery of the second window portion 52 and the portion of the back-side of the second window portion 52 using any adhesive (e.g., glue).

FIG. 15 illustrates another example of a flood barrier window system 10. Flood barrier window system 10 of FIG. 15 (and its components) may be substantially similar to flood barrier window system 10 of FIG. 13 (and its components). However, as is illustrated, the flood barrier window system 10 of FIG. 15 includes an interlayer 56 that extends out of the periphery of the window 44, wraps around all (or a portion) of the periphery of the first window portion 48, further wraps around the front-side of the first window portion 48, and extends vertically (e.g., upward) along a portion of the front-side of the first window portion 48. In some examples, this may allow the interlayer 56 to provide an additional water barrier along these areas, which may prevent (or help reduce) water from leaking above and/or below these areas. The interlayer 56 may be coupled to the periphery of the first window portion 48 and the portion of the front-side of the first window portion 48 using any adhesive (e.g., glue).

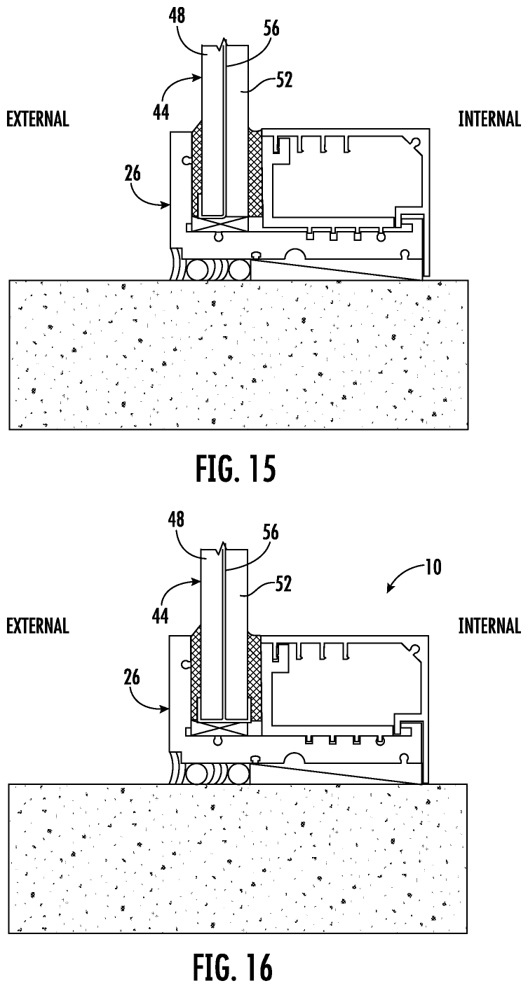

FIG. 16 illustrates another example of a flood barrier window system 10. Flood barrier window system 10 of FIG. 16 (and its components) may be substantially similar to flood barrier window system 10 of FIG. 13 (and its components). However, as is illustrated, the flood barrier window system 10 of FIG. 16 includes an interlayer 56 with two portions that extend out of the periphery of the window 44. The first portion of the interlayer 56 wraps around all (or a portion) of the periphery of the first window portion 48, further wraps around the front-side of the first window portion 48, and extends vertically (e.g., upward) along a portion of the front-side of the first window portion 48. The second portion of the interlayer 56 wraps around all (or a portion) of the periphery of the second window portion 52, further wraps around the back-side of the second window portion 52, and extends vertically (e.g., upward) along a portion of the back-side of the second window portion 52. In some examples, this may allow the interlayer 56 to provide an additional water barrier along these areas, which may prevent (or help reduce) water from leaking above and/or below these areas. The first and second portions of the interlayer 56 may be coupled to the periphery of the first window portion 48, the portion of the front-side of the first window portion 48, the periphery of the second window portion 52, and the portion of the back-side of the second window portion 52 using any adhesive (e.g., glue).

FIG. 17 illustrates another example of a flood barrier window system 10. Flood barrier window system 10 of FIG. 17 (and its components) may be substantially similar to flood barrier window system 10 of FIG. 13 (and its components). However, as is illustrated, the flood barrier window system 10 of FIG. 17 includes a window 44 having a first window portion 48 that is shorter in length than a second window portion 52. This may result in an extended interlayer 56, in some examples. The first window portion 48 may be shorter in length by any amount. Furthermore, as is also illustrated, the interlayer 56 may extend out of the periphery of the first window portion 48, but may not extend out of the periphery of the second window portion 52. In other examples, the interlayer 56 may extend out of the periphery of both the first window portion 48 and the second window portion 52 (such as in the examples discussed above).

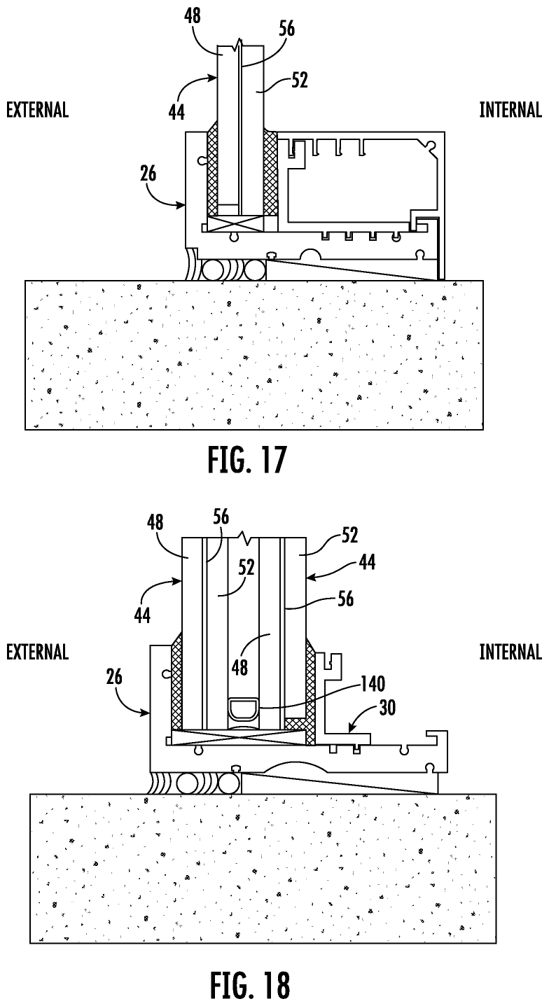

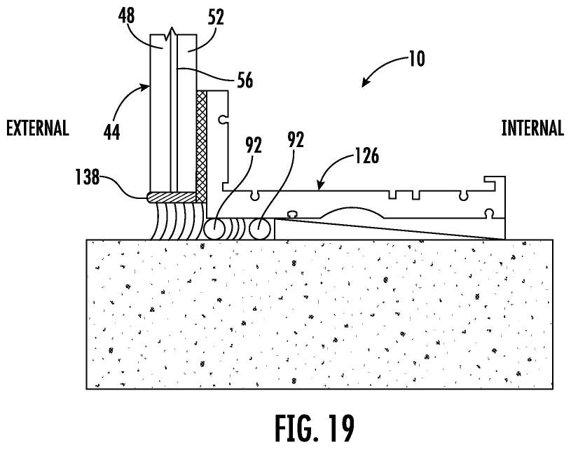

FIG. 18 illustrates another example of a flood barrier window system 10. Flood barrier window system 10 of FIG. 18 (and its components) may be substantially similar to flood barrier window system 10 of FIGS. 1A-1C (and its components). However, as is illustrated, the flood barrier window system 10 of FIG. 17 includes two windows 44 positioned next to each other, with a spacer 140 positioned in-between the windows 44. The spacer 140 may be any structure that keeps the windows 44 separated. The spacer 140 may be made of any suitable material, such as plastic or aluminum. As is also illustrated, the second window 44 (e.g., the interior window 44 in FIG. 18) includes a second window portion 52 that is shorter in length than a first window portion 48. This may result in an extended interlayer 56, in some examples. The second window portion 52 may be shorter in length by any amount.

FIG. 19 illustrates another example of a flood barrier window system 10. Flood barrier window system 10 of FIG. 19 (and its components) may be substantially similar to flood barrier window system 10 of FIG. 4 (and its components). However, as is illustrated, the flood barrier window system 10 of FIG. 19 includes an extruded seal 138 that is coupled to all (or a portion) of the periphery of the window 44. The extruded seal 138 may be a silicone sealant. One example of the extruded seal 138 is SPECTREM 1 by Tremco Inc. In some examples, the extruded seal 138 may provide an additional water barrier along the periphery of the window 44, which may prevent (or help reduce) water from leaking above and/or below this periphery. The extruded seal 138 may be coupled to the periphery of all (or a portion) of the window 44 using any adhesive (e.g., glue). As is also illustrated in FIG. 19, the flood barrier window system 10 includes the window seat 126, further includes two breaker rods 92 (as is discussed above), and also includes glazing tape 64 in-between the second window portion 52 and the window seat 126.

Modifications, additions, or omissions may be made to the flood barrier window system 10 of each of (or one or more of) FIGS. 1A-19 without departing from the scope of the disclosure. For example, although the flood barrier window system 10 has been described above as including cap(s) 34, in other examples, the flood barrier window system 10 may not include any cap(s) 34. As another example, although the water sealant system 84 (and its three levels of protection) has been described above in connection with the frame 22 and window 44, in other examples, the water sealant system 84 (and its three levels of protection) may be used with any other frame and/or window. As an example of this, the water sealant system 84 (and its three levels of protection) may be used with traditional frames and windows. As a further example, although the water sealant system 84 has been described above as including three levels of protection (i.e., the first level of sealant 88, the second level of sealant 96, and the gasket 100), in some examples, one or more of these levels of protection may not be used. As an example of this, the flood barrier window system 10 may be used with only the first level of sealant 88. As another example of this, the flood barrier window system 10 may be used with only the first level of sealant 88 and the gasket 100. Furthermore, although the window system 10 has been described above as providing protection for floods, in other examples, the window system 10 may provide protection for hurricanes, fire, blasts (e.g., explosions), ballistics (e.g., bullets), or any combination of the preceding. The window system 10 may also be used with insulated glass, single and multiple glass units, outside structurally glazed units, and/or captured systems.

This specification has been written with reference to various non-limiting and non-exhaustive embodiments or examples. However, it will be recognized by persons having ordinary skill in the art that various substitutions, modifications, or combinations of any of the disclosed embodiments or examples (or portions thereof) may be made within the scope of this specification. Thus, it is contemplated and understood that this specification supports additional embodiments or examples not expressly set forth in this specification. Such embodiments or examples may be obtained, for example, by combining, modifying, or reorganizing any of the disclosed steps, components, elements, features, aspects, characteristics, limitations, and the like, of the various non-limiting and non-exhaustive embodiments or examples described in this specification.

1. A window system, comprising:
a frame configured to be coupled to an opening in a structure, the frame comprising one or more window seats and one or more moveable window stops, wherein the one or more window seats are configured to surround all or a portion of a periphery of a window, wherein the one or more moveable window stops are configured to be moved and coupled to different positions along a depth of the one or more window seats; and
the window, wherein the window comprises a first window portion, a second window portion, and an interlayer positioned in-between the first window portion and the second window portion, wherein the interlayer extends out of the periphery of the window.

2. The window system of claim 1, wherein the interlayer is configured to extend in-between at least a portion of both the one or more window seats and the one or more moveable window stops.

3. The window system of claim 1, wherein the interlayer wraps around at least a portion of the periphery of the second window portion, wraps around a side of the second window portion, and extends vertically along a portion of the side of the second window portion.

4. The window system of claim 1, wherein each of the one or more window seats comprises a seat portion and further comprises a support portion configured to extend outward from the seat portion and past the periphery of the window on a side of the window.

5. The window system of claim 1, wherein each of the one or more moveable window stops comprises an anchor portion configured to be coupled to a respective window seat, wherein each of the one or more moveable window stops further comprises a stop portion configured to extend outward from the anchor portion and past the periphery of the window on a side of the window.

6. The window system of claim 5, wherein each of the anchor portions is configured to be coupled to the respective window seat by at least one of a plurality of teeth extending outward from the anchor portion.

7. The window system of claim 6, wherein the plurality of teeth are removable from the anchor portion.

8. The window system of claim 6, wherein the respective window seat comprises a plurality of pockets that are each configured to receive one of the plurality of teeth extending outward from the anchor portion.

9. The window system of claim 8, wherein:
the plurality of teeth are evenly spaced from each other; and
the plurality of pockets are evenly spaced from each other by the same amount as the plurality of teeth.

10. The window system of claim 1, wherein the frame further comprises one or more caps configured to be coupled to and cover one or more exposed portions of the one or more window seats and the one or more moveable window stops.

11. The window system of claim 1, further comprising one or more connectors configured to couple the frame to the opening in the structure.

12. The window system of claim 11, wherein each of the one or more connectors are configured to be positioned into each of:
at least one of the one or more window seats;
at least one of the one or more moveable window stops; and
a portion of the structure.

13. The window system of claim 1, further comprising a water sealant system comprising:
a first level of sealant configured to be positioned in a gap in-between the frame and the structure in a location positioned outward of a first backer rod; and
a second level of sealant configured to be positioned in the gap in-between the frame and the structure in a location positioned inward of the first backer rod and further positioned outward of a second backer rod.

14. A method, comprising:
positioning one or more window seats of a frame along all or a portion of a periphery of a window, wherein the window comprises a first window portion, a second window portion, and an interlayer positioned in-between the first window portion and the second window portion, wherein the interlayer extends out of the periphery of the window;
coupling one or more moveable window stops of the frame to the one or more window seats at a position along a depth of the one or more window seats, wherein the position along the depth is based on a thickness of the window;
inserting the frame and the window into an opening in a structure; and
coupling the frame to the opening in the structure.

15. The method of claim 14, further comprising:
prior to the coupling of the one or more moveable window stops of the frame to the one or more window seats, positioning a portion of the interlayer of the window in-between at least a portion of both the one or more window seats and the one or more moveable window stops.

16. The method of claim 14, wherein the interlayer wraps around at least a portion of the periphery of the second window portion, wraps around a side of the second window portion, and extends vertically along a portion of the side of the second window portion.

17. A window system, comprising:
a frame configured to be coupled to an opening in a structure, the frame comprising one or more window seats, wherein an exterior-facing surface of each of the one or more window seats is configured to be coupled to an interior-facing surface of a window; and
the window, wherein the window comprises a first window portion, a second window portion, and an interlayer positioned in-between the first window portion and the second window portion, wherein the interlayer extends out of the periphery of the window and wraps around at least a portion of the periphery of the second window portion.

18. The window system of claim 17, further comprising a water sealant system comprising:
a first level of sealant configured to be positioned in a gap in-between the frame and the structure in a location positioned outward of a first backer rod; and
a second level of sealant configured to be positioned in the gap in-between the frame and the structure in a location positioned inward of the first backer rod and further positioned outward of a second backer rod.

19. A method, comprising:
inserting one or more window seats of a frame into an opening in a structure;
coupling the frame to the opening in the structure; and
coupling an interior-facing surface of a window to an exterior-facing surface of each of the one or more window seats, wherein the window comprises a first window portion, a second window portion, and an interlayer positioned in-between the first window portion and the second window portion, wherein the interlayer extends out of the periphery of the window and wraps around at least a portion of the periphery of the second window portion.

20. The method of claim 19, further comprising:
positioning a first level of sealant in a gap in-between the frame and the structure in a location positioned outward of a first backer rod; and
positioning a second level of sealant in the gap in-between the frame and the structure in a location positioned inward of the first backer rod and further positioned outward of a second backer rod.
